(19) United States
(12) Patent Application Publication
(10) Pub. No.: US 2013/0254312 A1
(43) Pub. Date: Sep. 26, 2013

(54) COMPUTER IMPLEMENTED METHODS AND APPARATUS FOR FINDING PEOPLE IN A PHYSICAL ENVIRONMENT

(71) Applicant: SALESFORCE.COM, INC., San Francisco, CA (US)

(72) Inventors: Kanishka Maheshwari, San Francisco, CA (US); Mustafa Paksoy, San Francisco, CA (US)

(73) Assignee: salesforce.com, inc., San Francisco, CA (US)

(21) Appl. No.: 13/850,109

(22) Filed: Mar. 25, 2013

Related U.S. Application Data
(60) Provisional application No. 61/615,425, filed on Mar. 26, 2012.

(51) Int. Cl. H04L 29/08

(52) U.S. Cl. CPC H04L 67/22
USPC 709/206

(57) ABSTRACT

Disclosed are methods, apparatus, systems, and computer readable storage media for finding people in a physical environment. A server receives data indicating a location and identifies events corresponding to the location. Event data is transmitted to a computing device. Attendees at a selected event are identified and transmitted to the computing device. The server can receive a message addressed to an attendee and store data regarding the attendee. In some implementations, attendees may be identified from content posted on a social network. Additionally, certain attendees or events may be emphasized.

### PRIORITY DATA

This patent document claims priority to co-pending and commonly assigned U.S. Provisional Patent Application No. 61/615,425, titled “Methods and Systems for Automatically Creating Leads in an On-Demand Services Environment”, by K. Maheshwari and M. Paksoy, filed on Mar. 26, 2012 (Attorney Docket No. 834PROV), which is hereby incorporated by reference in its entirety and for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document relates generally to the use of customer relationship management (CRM) systems and online social networks, and more specifically, creating, maintaining, and analyzing sales leads from content published on online social networks.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Management of marketing or sales leads can be provided in a cloud computing context. However, using conventional leads generation techniques, it is difficult to efficiently obtain and maintain data regarding sales leads found through a variety of sources, including online social networks. For example, users of online social networks may be identified as a lead, opportunity, contact, case, and/or account. However, extracting, storing, and analyzing information to determine leads can be difficult.

### BRIEF DESCRIPTION OF THE DRAWINGS

The included drawings are for illustrative purposes and serve only to provide examples of possible structures and operations for the disclosed inventive systems, apparatus, methods and computer readable media for finding people in a physical environment based on data obtained from an online social network. These drawings in no way limit any changes in form and detail that may be made by one skilled in the art without departing from the spirit and scope of the disclosed implementations.

FIG. 1 shows a block diagram of an example of an environment 10 in which an on-demand database service can be used in accordance with some implementations.

FIG. 2 shows a block diagram of an example of some implementations of elements of FIG. 1 and various possible interconnections between these elements.

FIG. 3A shows a system diagram illustrating an example of architectural components of an on-demand database service environment 1200 according to some implementations.

FIG. 3B shows a system diagram further illustrating an example of architectural components of an on-demand database service environment according to some implementations.

FIG. 4A shows a system diagram of an example of architectural components 400 for finding people in a physical environment according to some implementations.

FIG. 4B shows a system diagram of an example of architectural components 450 for finding people in a physical environment according to some implementations.

FIG. 5 shows a flowchart of an example of a computer implemented method 500 for finding people in a physical environment in accordance with some implementations.

FIG. 6 shows a map with a user location and events at different locations in accordance with some implementations.

FIG. 7 depicts an event with multiple sub-events in accordance with some implementations.

FIG. 8 shows an example of a graphical user interface (GUI) 800 for presenting identified events data, according to some implementations.

FIG. 9 shows an example of a graphical user interface (GUI) 900 for presenting attendee data, according to some implementations.

FIG. 10 shows a flowchart of an example of a computer implemented method 1000 for finding people in a physical environment in accordance with some implementations.

FIG. 11 depicts an event with sub-events in accordance with some implementations.

FIG. 12 shows an example of a graphical user interface (GUI) 1300 for presenting data, according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described or referenced herein are directed to different systems, apparatus, methods and computer-readable storage media for finding people in a physical environment. In some examples, sales leads can be created, managed, and analyzed from content published to online social networks such as Facebook®, Twitter®, Youtube®, Google+®, LinkedIn®, and other services. Leads received from social networks may be identified, managed, and tracked by a customer relationship management (CRM) system, for instance, using products and services offered by salesforce.com, inc. Data, such as user comments and profile information may be stored by the CRM system. Users may also be identified as participating in an event. Thus, users of social networks may be identified as leads at events, such as industry conventions or shows.

For example, a user may use a computing device to provide data regarding a location. Accordingly, events, such as conventions, fairs, seminars, or other types of social gatherings close to the location may be identified. The user of the computing device may select a particular event to generate leads from. For example, users of an online social network may publish comments or posts related to an event. Thus, the online social network may be searched for users commenting on the event. Users commenting on the event may be identified as potential leads.

The CRM system may also analyze the comments associated with the event to determine if the user attending the event is attending for a particular reason, such as looking to purchase or sell a product. Certain users with particular demographics, such as employment details (e.g., a particular position, title, place of employment), education, interests, etc. may also be identified. Accordingly, certain users of the online social network determined to be participating in the event may be identified and emphasized. As such, leads to pursue at an event may be generated for a sales or marketing representative.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

Online social networks are increasingly becoming a common way to facilitate communication among people who can be recognized as users of a social networking system. Some online social networks can be implemented in various settings, including organizations, e.g., enterprises such as companies or business partnerships, academic institutions, or groups within such an organization.

In some online social networks, users can access one or more information feeds, which include information updates presented as items or entries in the feed. Such a feed item can include a single information update or a collection of individual information updates. A feed item can include various types of data including character-based data, audio data, image data and/or video data. For example, a post related to an online marketing campaign may appear as a feed item. An information feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

Additional examples of systems, apparatus, and methods are disclosed herein for implementing enterprise level social and business information networking. Such implementations can provide more efficient use of a database system. For instance, a user of a database system may not easily know when important information in the database has changed, e.g., about a project or client. Implementations can provide feed tracked updates about such changes and other events, thereby keeping users informed.

By way of example, a user can update a record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

Mechanisms and methods for providing systems implementing enterprise level social and business information networking are disclosed herein with reference to several implementations. Examples of database systems are described and can provide a platform for tracking events related to a record, actions of a user, and messages about a user or record. The disclosed systems support various data structures of feeds, the customization of feeds, selection of records and users to follow, generation of feeds, and display of feeds in suitable presentations on a user's display device.

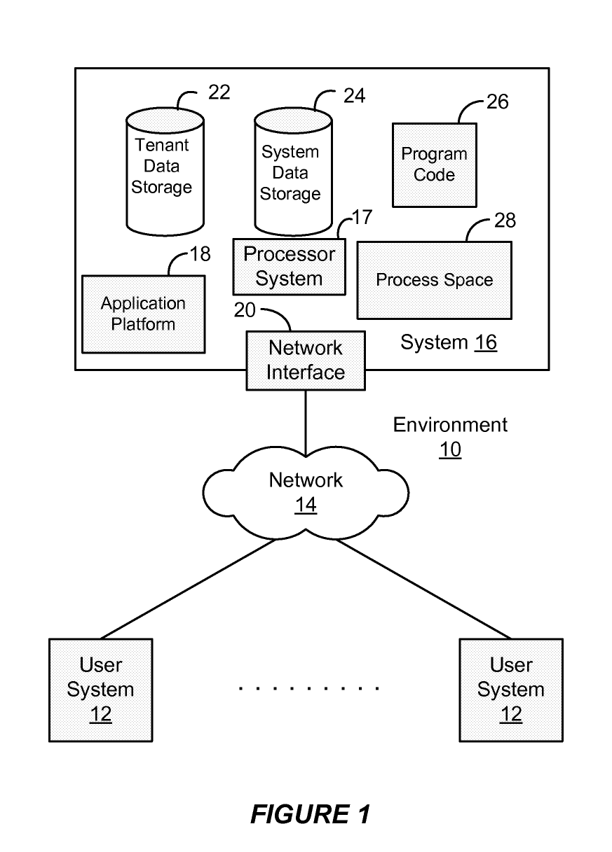

FIG. 1 shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

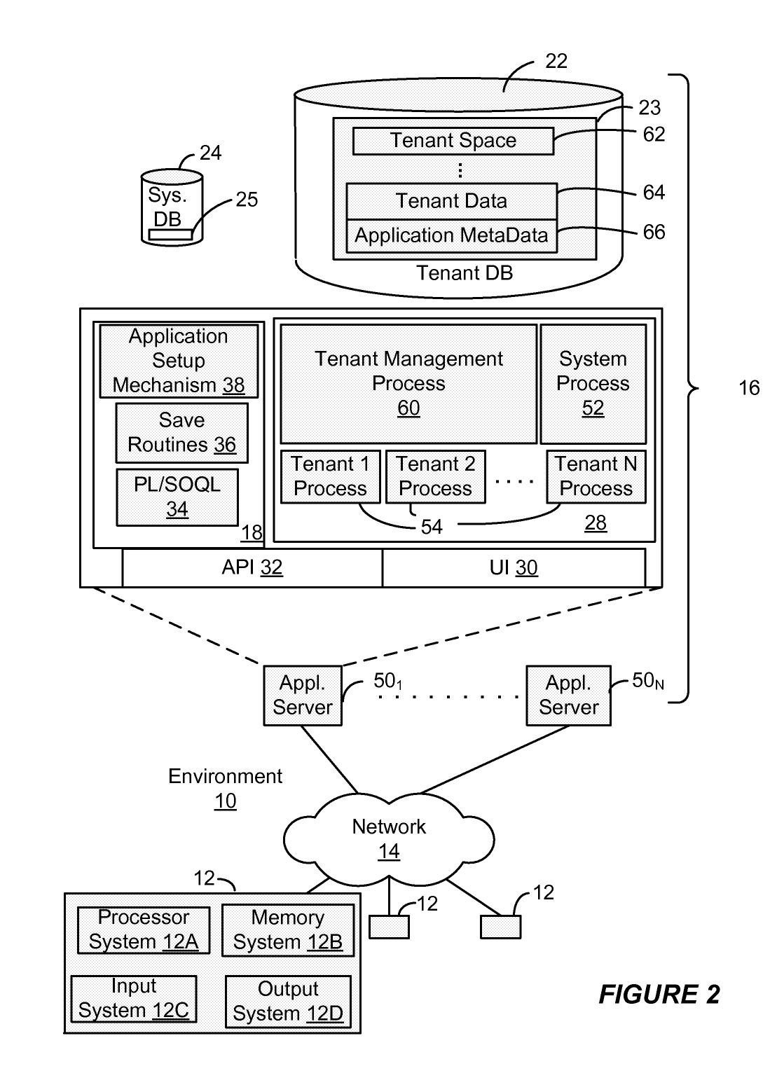

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 1 (and in more detail in FIG. 2) user systems 12 might interact via a network 14 with an on-demand database service, which is implemented in the example of FIG. 1 as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 1, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 1 and 2, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

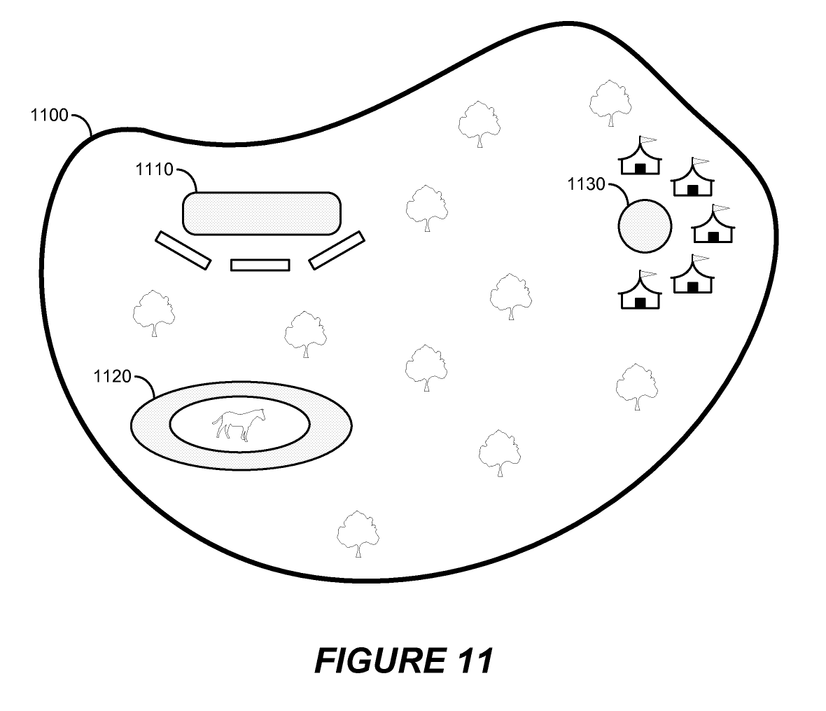

FIG. 2 shows a block diagram of an example of some implementations of elements of FIG. 1 and various possible interconnections between these elements. That is, FIG. 2 also illustrates environment 10. However, in FIG. 2 elements of system 16 and various interconnections in some implementations are further illustrated. FIG. 2 shows that user system 12 may include processor system 12A, memory system 12B, input system 12C, and output system 12D. FIG. 11B shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

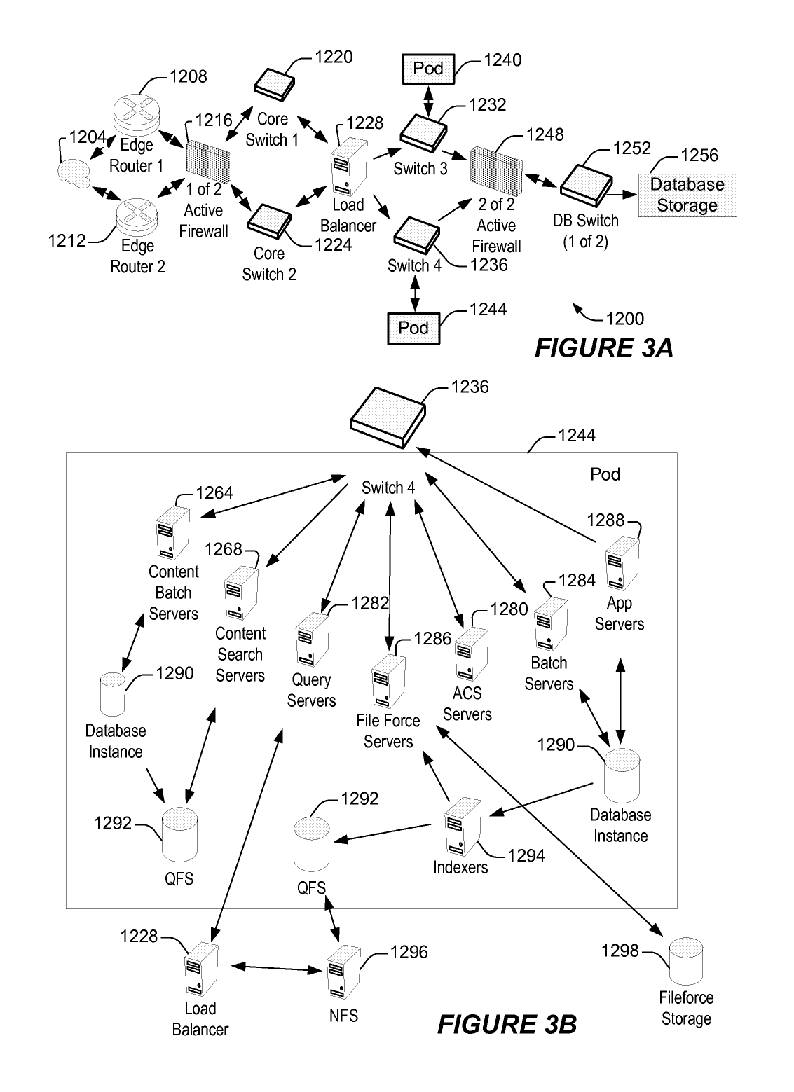

FIG. 3A shows a system diagram illustrating an example of architectural components of an on-demand database service environment 1200 according to some implementations. A client machine located in the cloud 1204, generally referring to one or more networks in combination, as described herein, may communicate with the on-demand database service environment via one or more edge routers 1208 and 1212. A client machine can be any of the examples of user systems 12 described above. The edge routers may communicate with one or more core switches 1220 and 1224 via firewall 1216. The core switches may communicate with a load balancer 1228, which may distribute server load over different pods, such as the pods 1240 and 1244. The pods 1240 and 1244, which may each include one or more servers and/or other computing resources, may perform data processing and other operations used to provide on-demand services. Communication with the pods may be conducted via pod switches 1232 and 1236. Components of the on-demand database service environment may communicate with a database storage 1256 via a database firewall 1248 and a database switch 1252.

As shown in FIGS. 3A and 3B, accessing an on-demand database service environment may involve communications transmitted among a variety of different hardware and/or software components. Further, the on-demand database service environment 1200 is a simplified representation of an actual on-demand database service environment. For example, while only one or two devices of each type are shown in FIGS. 3A and 3B, some implementations of an on-demand database service environment may include anywhere from one to many devices of each type. Also, the on-demand database service environment need not include each device shown in FIGS. 3A and 3B, or may include additional devices not shown in FIGS. 3A and 3B.

Moreover, one or more of the devices in the on-demand database service environment 1200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1204 is intended to refer to a data network or plurality of data networks, often including the Internet. Client machines located in the cloud 1204 may communicate with the on-demand database service environment to access services provided by the on-demand database service environment. For example, client machines may access the on-demand database service environment to retrieve, store, edit, and/or process information.

In some implementations, the edge routers 1208 and 1212 route packets between the cloud 1204 and other components of the on-demand database service environment 1200. The edge routers 1208 and 1212 may employ the Border Gateway Protocol (BGP). The BGP is the core routing protocol of the Internet. The edge routers 1208 and 1212 may maintain a table of IP networks or ‘prefixes’, which designate network reachability among autonomous systems on the Internet.

In one or more implementations, the firewall 1216 may protect the inner components of the on-demand database service environment 1200 from Internet traffic. The firewall 1216 may block, permit, or deny access to the inner components of the on-demand database service environment 1200 based upon a set of rules and other criteria. The firewall 1216 may act as one or more of a packet filter, an application gateway, a stateful filter, a proxy server, or any other type of firewall.

In some implementations, the core switches 1220 and 1224 are high-capacity switches that transfer packets within the on-demand database service environment 1200. The core switches 1220 and 1224 may be configured as network bridges that quickly route data between different components within the on-demand database service environment. In some implementations, the use of two or more core switches 1220 and 1224 may provide redundancy and/or reduced latency.

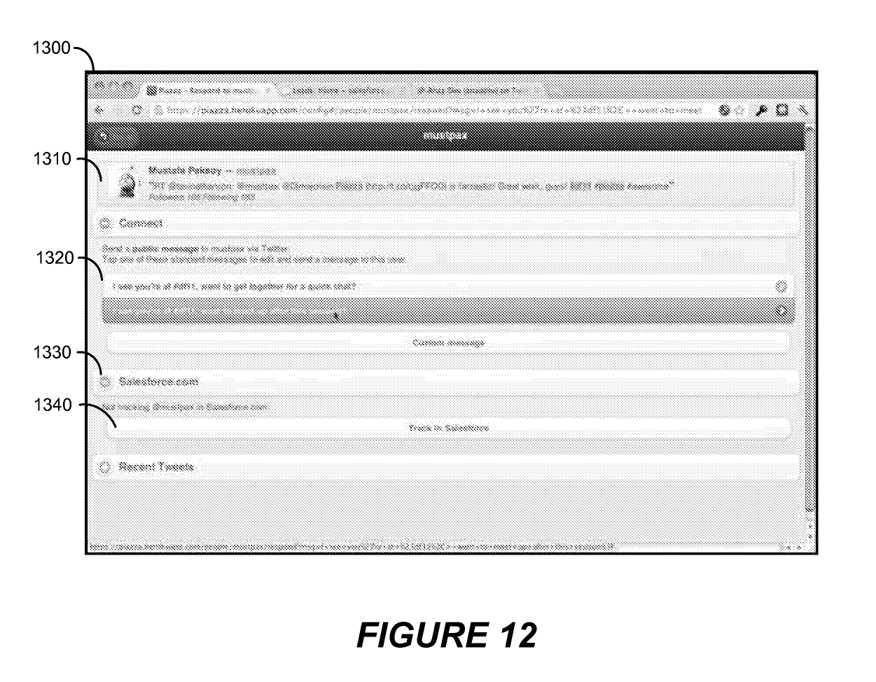

In some implementations, the pods 1240 and 1244 may perform the core data processing and service functions provided by the on-demand database service environment. Each pod may include various types of hardware and/or software computing resources. An example of the pod architecture is discussed in greater detail with reference to FIG. 12B.

In some implementations, communication between the pods 1240 and 1244 may be conducted via the pod switches 1232 and 1236. The pod switches 1232 and 1236 may facilitate communication between the pods 1240 and 1244 and client machines located in the cloud 1204, for example via core switches 1220 and 1224. Also, the pod switches 1232 and 1236 may facilitate communication between the pods 1240 and 1244 and the database storage 1256.

In some implementations, the load balancer 1228 may distribute workload between the pods 1240 and 1244. Balancing the on-demand service requests between the pods may assist in improving the use of resources, increasing throughput, reducing response times, and/or reducing overhead. The load balancer 1228 may include multilayer switches to analyze and forward traffic.

In some implementations, access to the database storage 1256 may be guarded by a database firewall 1248. The database firewall 1248 may act as a computer application firewall operating at the database application layer of a protocol stack. The database firewall 1248 may protect the database storage 1256 from application attacks such as structure query language (SQL) injection, database rootkits, and unauthorized information disclosure.

In some implementations, the database firewall 1248 may include a host using one or more forms of reverse proxy services to proxy traffic before passing it to a gateway router. The database firewall 1248 may inspect the contents of database traffic and block certain content or database requests. The database firewall 1248 may work on the SQL application level atop the TCP/IP stack, managing applications'connection to the database or SQL management interfaces as well as intercepting and enforcing packets traveling to or from a database network or application interface.

In some implementations, communication with the database storage 1256 may be conducted via the database switch 1252. The multi-tenant database storage 1256 may include more than one hardware and/or software components for handling database queries. Accordingly, the database switch 1252 may direct database queries transmitted by other components of the on-demand database service environment (e.g., the pods 1240 and 1244) to the correct components within the database storage 1256.

In some implementations, the database storage 1256 is an on-demand database system shared by many different organizations. The on-demand database system may employ a multi-tenant approach, a virtualized approach, or any other type of database approach. An on-demand database system is discussed in greater detail with reference to FIGS. 1 and 2.

FIG. 3B shows a system diagram further illustrating an example of architectural components of an on-demand database service environment according to some implementations. The pod 1244 may be used to render services to a user of the on-demand database service environment 1200. In some implementations, each pod may include a variety of servers and/or other systems. The pod 1244 includes one or more content batch servers 1264, content search servers 1268, query servers 1282, file force servers 1286, access control system (ACS) servers 1280, batch servers 1284, and app servers 1288. Also, the pod 1244 includes database instances 1290, quick file systems (QFS) 1292, and indexers 1294. In one or more implementations, some or all communication between the servers in the pod 1244 may be transmitted via the switch 1236.

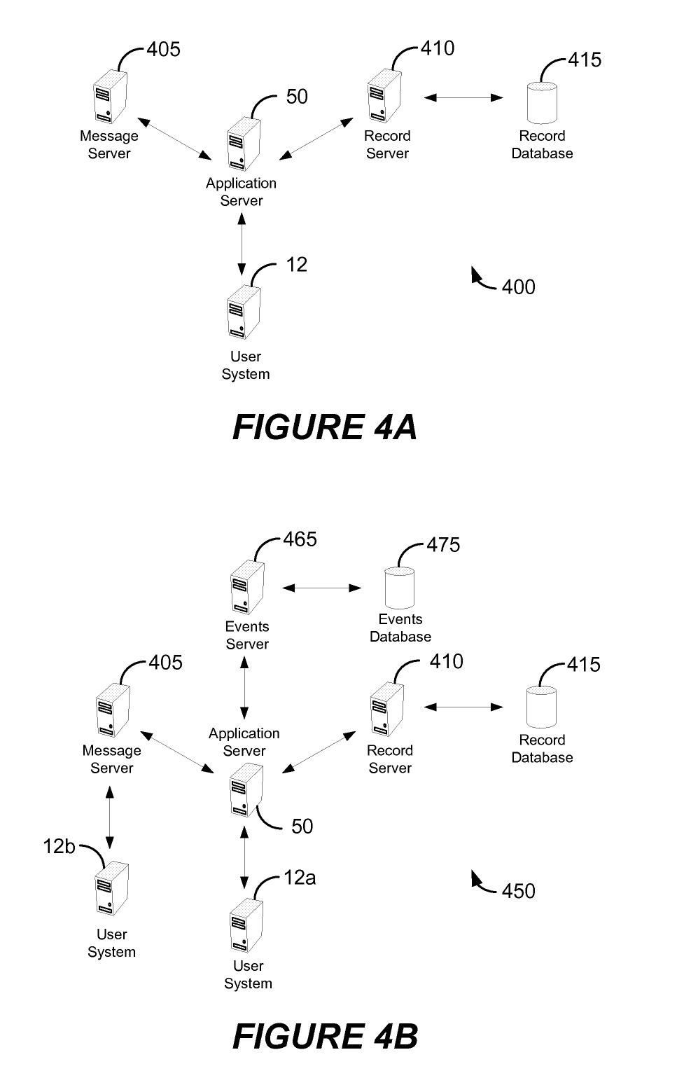

In some implementations, the app servers 1288 may include a hardware and/or software framework dedicated to the execution of procedures (e.g., programs, routines, scripts) for supporting the construction of applications provided by the on-demand database service environment 1200 via the pod 1244. In some implementations, the hardware and/or software framework of an app server 1288 is configured to execute operations of the services described herein, including performance of the blocks of methods described with reference to FIGS. 4-12. In alternative implementations, two or more app servers 1288 may be included and cooperate to perform such methods, or one or more other servers described herein can be configured to perform the disclosed methods.

The content batch servers 1264 may handle requests internal to the pod. These requests may be long-running and/or not tied to a particular customer. For example, the content batch servers 1264 may handle requests related to log mining, cleanup work, and maintenance tasks.

The content search servers 1268 may provide query and indexer functions. For example, the functions provided by the content search servers 1268 may allow users to search through content stored in the on-demand database service environment.

The file force servers 1286 may manage requests for information stored in the Fileforce storage 1298. The Fileforce storage 1298 may store information such as documents, images, and basic large objects (BLOBs). By managing requests for information using the file force servers 1286, the image footprint on the database may be reduced.

The query servers 1282 may be used to retrieve information from one or more file systems. For example, the query system 1282 may receive requests for information from the app servers 1288 and then transmit information queries to the NFS 1296 located outside the pod.

The pod 1244 may share a database instance 1290 configured as a multi-tenant environment in which different organizations share access to the same database. Additionally, services rendered by the pod 1244 may call upon various hardware and/or software resources. In some implementations, the ACS servers 1280 may control access to data, hardware resources, or software resources.

In some implementations, the batch servers 1284 may process batch jobs, which are used to run tasks at specified times. Thus, the batch servers 1284 may transmit instructions to other servers, such as the app servers 1288, to trigger the batch jobs.

In some implementations, the QFS 1292 may be an open source file system available from Sun Microsystems® of Santa Clara, Calif. The QFS may serve as a rapid-access file system for storing and accessing information available within the pod 1244. The QFS 1292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1268 and/or indexers 1294 to identify, retrieve, move, and/or update data stored in the network file systems 1296 and/or other storage systems.

In some implementations, one or more query servers 1282 may communicate with the NFS 1296 to retrieve and/or update information stored outside of the pod 1244. The NFS 1296 may allow servers located in the pod 1244 to access information to access files over a network in a manner similar to how local storage is accessed.

In some implementations, queries from the query servers 1222 may be transmitted to the NFS 1296 via the load balancer 1228, which may distribute resource requests over various resources available in the on-demand database service environment. The NFS 1296 may also communicate with the QFS 1292 to update the information stored on the NFS 1296 and/or to provide information to the QFS 1292 for use by servers located within the pod 1244.

In some implementations, the pod may include one or more database instances 1290. The database instance 1290 may transmit information to the QFS 1292. When information is transmitted to the QFS, it may be available for use by servers within the pod 1244 without using an additional database call.

In some implementations, database information may be transmitted to the indexer 1294. Indexer 1294 may provide an index of information available in the database 1290 and/or QFS 1292. The index information may be provided to file force servers 1286 and/or the QFS 1292.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

FIG. 4A shows a system diagram illustrating an example of architectural components 400 for finding people in a physical environment according to some implementations. Architectural components 400 in FIG. 4A may provide for communications to be transmitted among a variety of different hardware and/or software components. For example, architectural components 400 may include User System 12, Application Server 50, Record Server 410, Record Database 415 storing data, and Message Server 405 storing content on a social network.

The various components are able to communicate with each other over the Internet or a combination of networks including the Internet. For example, in some implementations, User System 12 may communicate with an Application Server 50. Application Server 50 may further communicate with additional servers, such as Message Server 405 and Record Server 410. Application Server 50 may also store user credentials, such as a username and password, which may be used to access Message Server 405 or Record Server 410. In other implementations, Application Server 50 may determine if User System 12 is already logged in to a server such as Message Server 405 and then obtain data from Message Server 405, or alternatively, prompt User System 12 to log in to Message Server 405. Accordingly, Application Server 50 may process data received from User System 12, and determine that data from Message Server 405 and/or Record Server 410 may need to be retrieved, or that data must be transmitted to Message Server 405 and/or Record Server 410. Application Server 50 may also transmit data to User System 12, including, but not limited to, data received from Message Server 405 or Record Server 410. Additionally, Message Server 405, Application Server 50, Record Server 410, and User System 12 may also communicate with additional resources such as databases. For example, Record Server 410 may communicate with Record Database 415 to either record or retrieve data.

For example, Application Server 50 may receive data regarding a geographic location from User System 12. Application Server 50 may process the geographic location data and subsequently determine that additional data, such as events or people near the location identified in the geographic location data, may be needed from Message Server 405, Record Server 410, or any other server or resource. In some implementations, Message Server 405 may relay messages specific to a particular social network, and Record Server 410 may be a dedicated server configured to store and retrieve data in Record Database 415.

Accordingly, Application Server 50 may identify events near the location identified in the geographic location data and subsequently provide User System 12 with the identified events. User System 12 may transmit a selected event back to Application Server 50. As such, Application Server 50 may communicate with Message Server 405 to retrieve data regarding the selected event. For example, if Message Server 405 is a social network, Application Server 50 may utilize an API to communicate with the social network in Message Server 405. In some implementations, Application Server 50 may transmit search terms based on the selected event in order to retrieve messages posted by users of the social network represented by Message Server 405. In effect, Application Server 50 may be able to retrieve a list of users, and data such as their corresponding messages, which are referring to the selected event by posting content on the social network. Data retrieved by Application Server 50 may also be displayed on User System 12.

The list of users may be transmitted by Application Server 50 to User System 12. In some implementations, User System 12 may further transmit a message regarding one of the users on the social network to Application Server 50. Application Server 50 may subsequently communicate with Message Server 415 and transmit the message to the social network. Additionally, all interactions and data transmitted between the architectural components 400 may be recorded by Record Server 410 in Record Database 415.

User System 12 may be any type of computing device. For example, User System 12 may be a portable electronic device such as a smartphone, tablet, laptop, etc. User System 12 may also be another server or a desktop computer.

FIG. 4B shows a system diagram illustrating an example of architectural components 450 for finding people in a physical environment according to some implementations. Just as FIG. 4A, architectural components 450 in FIG. 4B may involve communications transmitted among a variety of different hardware and/or software components. For example, architectural components 450 may include components similar to FIG. 4A including User System 12a, Application Server 50, Record Server 410, Record Database 415, and Message Server 405. Additionally, architectural components 450 may include additional devices such as User System 12b, Events Server 465, and Events Database 475.

In FIG. 4B, Application Server 50 may communicate with Events Server 465 to retrieve data regarding events corresponding to the location identified in the geographic location data received from User System 12a. Events Server 465 may be another social network, the same social network as Message Server 405, a resource within a corporate intranet, calendar service, website, or any other server or resource. In any case, Events Server 465 may communicate with Events Database 475 to retrieve, and then transmit, identified events to Application Server 50. In some implementations, Application Server 50 may store user authentication credentials, such as a username and/or password, to gain access to the data stored by Events Server 465. In another implementation, the user authentication credentials may be received by Application Server 50 from User System 12a. Application Server 50 may also store credentials for Message Server 405, or receive credentials for Message Server 405 from User System 12a. Accordingly, Application Server 50, Message Server 405, and Events Server 465 may all be separate social networks. In other implementations, Message Server 405 and Events Server 465 may be part of one social network whereas Application Server 50 may be another social network. In other implementations, Message Server 405 and Events Server 465 may both be social networks, but Application Server 50 may be a cloud-based customer relationship management system interacting with the social networks to find leads.

Architectural components 450 in FIG. 4B include a first User System 12a and a second User System 12b. The user of User System 12b may be a user of the social network on Message Server 405. Additionally, the user of User System 12b may be a user who has posted a message regarding the selected event on the social network and to whom User System 12a has directed a message to via Application Server 50. Accordingly, Application Server 50 may direct the message from User System 12a to Message Server 405. Message Server 405 may subsequently transmit the message to User System 12b. In other implementations, Application Server 50 may directly communicate with User System 12b by skipping Message Server 405. In some implementations, contact information for User System 12b may be collected from the social network on Message Server 405. The contact information may then be used to communicate directly with User System 12b and skipping Message Server 405.

As such, architectural components 400 in FIG. 4A and architectural components 450 in FIG. 4B illustrate an example of finding people in a physical environment according to some implementations.

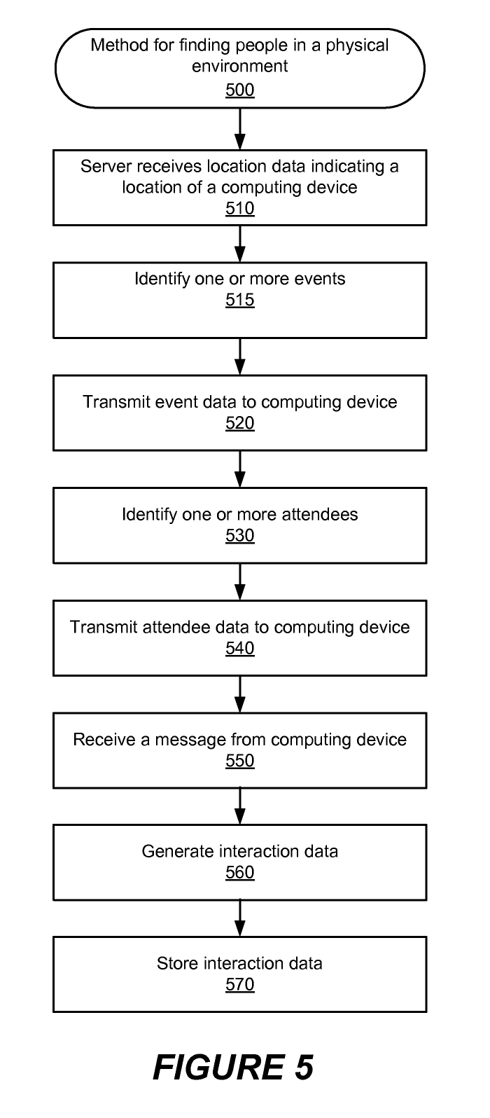

FIG. 5 shows a flowchart of an example of a method 500 for finding people in a physical environment in accordance with some implementations. Method 500 (and other methods described herein) may be implemented by the architectural components of FIGS. 4A and 4B. In various implementations, blocks may be reordered, omitted, combined, or split into additional blocks for method 500, as well as other methods described herein.

In block 510, a server, such as Application Server 50 of FIGS. 4A and 4B, receives location data indicating a location from a computing device, such as User System 12 or 12a of FIGS. 4A and 4B, respectively. For example, the location data may be GPS coordinates, longitude and latitude coordinates, street address, city, county, region, country, landmark, building, campus, event, or other indications of the computing device's location. In some implementations, the location data may be geo-location data generated by a smartphone or other portable electronic device.

In block 515, one or more events occurring corresponding to the location are identified. Events may be identified through a variety of sources, such as another website, social networks, corporate intranet resources, calendar systems, databases, or servers. In any case, events corresponding to the location received from the computing device are identified.

In one implementation, events within a predetermined distance of the location may be identified. For example, events within 5 miles of a location may be identified by querying a resource, such as a database, for a list of events. The list of events may be filtered by determining the distance between the location and site of the event and filtering out the events that are outside of the 5 mile range. In other implementations, the distance may be changed. In other implementations, the distance may be variable based upon the number of events found. For example, the distance may increase until a threshold of a number of events is identified.

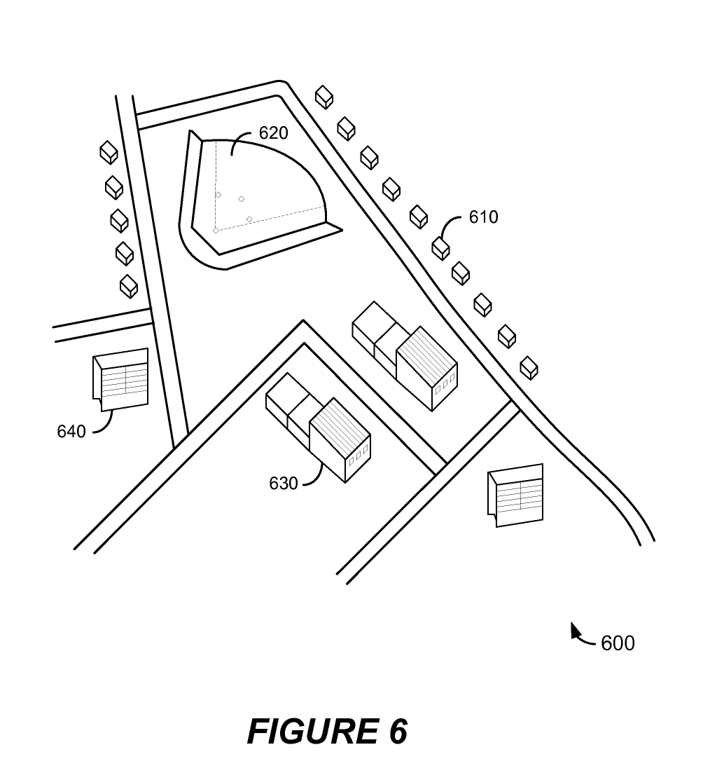

As an example, FIG. 6 shows a map with a user location 610 and a variety of events held at different locations: baseball game 620, conference 630, and seminar 640. In method 500, a location received from a computing device may be used to determine which events should be transmitted to the computing device. If events within 5 miles are selected, and seminar 640 is 7 miles from location 610, but baseball game 620 and conference 630 are within 5 miles, then baseball game 620 and conference 630 are identified as events corresponding to the location, whereas seminar 640 is excluded.

As another example, a user may simply identify a city as a location, such as “San Francisco.” Accordingly, a resource may be queried for a list of events and their corresponding addresses. The list of events may further be filtered by the address information for each event, and filtering out events that do not take place in “San Francisco.” Additionally, if a server or resource only contains a list of events, but lacks locations or addresses, an additional resource may be contacted to retrieve the corresponding address information for the events. Thus, multiple resources, such as multiple social networks or databases, may be queried to generate information regarding events.

In some implementations, event data such as the schedule may also be identified along with the event. The event data may be from the same resource used to identify events, or may be another resource, such as another social network, database, or website. Accordingly, incidents that are to occur at the event, including topics, speakers, or sub-events may be identified with the identified events. Additionally, other types of event-related data may be identified. For example, sponsors of the event may also be identified and used in the methods disclosed herein. In effect, any type of data or characteristic related to the event herein may be included in the event data.

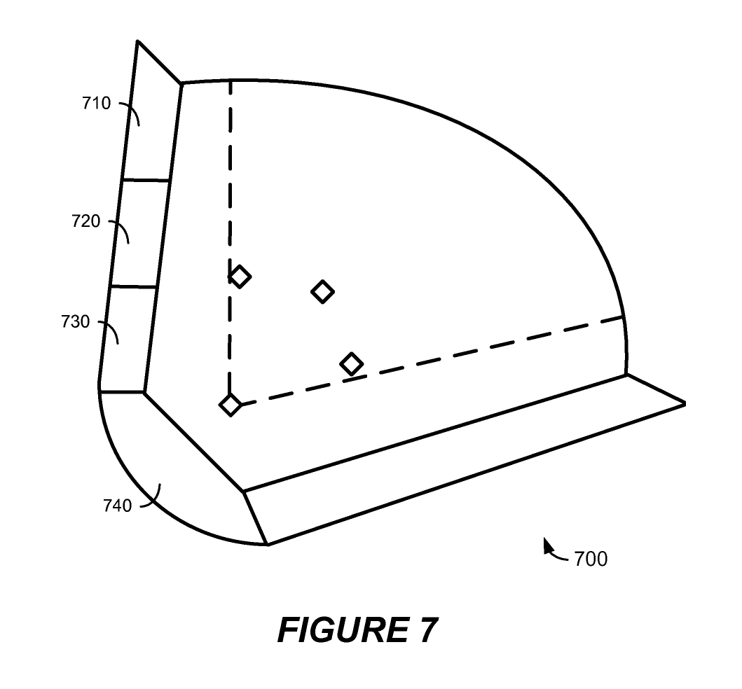

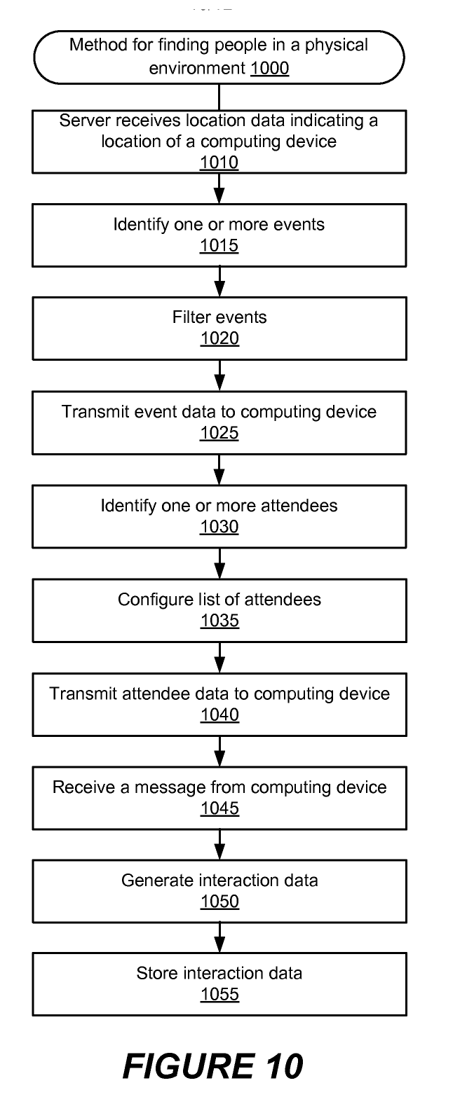

In one implementation, events or sub-events within a single building, facility, or campus may be identified. For example, a single event, such as a conference, may include several parallel seminars, presentations, booths, or discussions. Accordingly, a computing device may select an event as a location and receive a list of sub-events corresponding to the location. As an example, FIG. 7 depicts a baseball stadium holding an event 700. However, different sections of the stadium may hold sub-events 710, 720, 730, and 740 throughout the stadium. Accordingly, a list of the sub-events may be identified and transmitted. Additionally, the sub-events may also be filtered based on location, distance, or other criteria, as is discussed later with respect to block 1020 of FIG. 10.

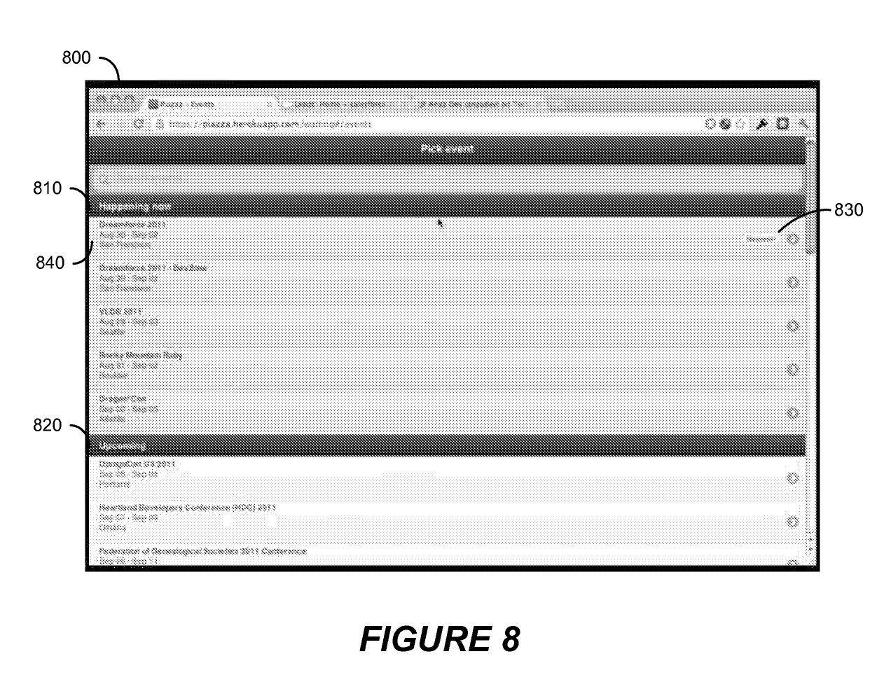

Thus, events, and data related to the events, corresponding to a location may be identified and then transmitted to a computing device in block 520. FIG. 8 shows an example of a presentation of identified events data in the form of a Graphical User Interface (GUI) 800 as displayed on a display device, according to some implementations. In this example, GUI 800 includes a list of events. For example, in FIG. 8, events are split into 2 categories: events “happening now” 810 and “upcoming events” 820. In other implementations, events that occurred in the past may also constitute another category. Accordingly, the events may be ordered and/or grouped. As such, the events list may be configured to push certain types of events, such as events currently ongoing, to the top of the list and events in the past or future to be on the bottom of the list. The lists may also be configured in other ways, for example, by having the ongoing events on the left side of the GUI and future events on the right side of the GUI. Additionally, events may be ordered in regard to the distance from the computing device's location.

In some implementations, additional graphical or textual indications signifying a particular characteristic of an event may be displayed with the event information on the list of events. For example, in FIG. 8, graphical indicator 830 is displayed next to an event. Graphical indicator 830 may signify a variety of characteristics. For example, it may indicate the closest event. Alternatively, it may signify the most popular event, a new event, a free event, or other characteristics. The list of events may also be configured to give priority to the preceding characteristics (i.e. configure the order of events in the list such that events with the characteristic are shown first, or filter out other events without the characteristic).

In block 530, one or more attendees at an event may be identified. For example, if the event data transmitted in block 520 contains a list of events, such as event 850 of FIG. 8 signifying the event “Dreamforce,” and the event 850 is selected, attendees at the event may be determined. One or multiple social networks may be accessed to determine attendees at the event.

Attendees at a selected event may be determined through a variety of techniques. In one implementation, attendees are identified by searching through content posted by the attendees on a social network. For example, content on the social network may be searched to find attendees posting content with geographical tags or indicators corresponding to a location of the selected event. Content may include graphics, photos, videos, text, etc. Content may also include interactions related to the member on the social network, such as “liking” the event, sub-event, person speaking at the event, or incident scheduled to be occurring at the event.

Additionally, content may be searched and analyzed, such as looking for keywords or using semantic analysis, to determine if a member on a social network is currently at an event, may be at an event, was at an event in the past, or will be at an event in the future. For example, the member of a social network may post a text on a social network stating “Marc Benioff is giving an incredible speech at Dreamforce right now!” Accordingly, at block 530, the member of the social network is identified as a current attendee at the event Dreamforce because the member is determined to be presently discussing the event “Dreamforce” and/or a particular incident or sub-event (i.e. a speech by Marc Benioff) at the event “Dreamforce.” As another example, a member of the social network may post a message stating “Marc Benioff is giving an incredible speech at Dreamforce. I can't wait to see what happens tomorrow!” Accordingly, by looking at the date when the message was posted on the social network, as well as the content of the message, the member may be determined to be an attendee at the event on the day of the message as well as the following day. Additionally, members of the social network referring to the event may also be identified as potential attendees. For example, a member posting a message of “Marc Benioff is speaking at Dreamforce! Yay!” may be determined to be speaking of the event because they refer to the selected event, “Dreamforce,” and/or an incident (i.e., Marc Benioff's scheduled speech) set to take place at “Dreamforce.” Members posting graphics, such as advertisements for an event, may also be identified as potential attendees.

Search terms to determine if a member on a social network is at an event may be received from a server. In one implementation, when identifying events in block 515, the event data may include search terms corresponding to the events. For example, the event “Dreamforce” along with corresponding search term “#df12” may be received from Events Server 465 of FIG. 4B.

Additionally, search terms may be created for events. For example, if the conference “Dreamforce” is being held in the year “2012” in the city of “San Francisco,” multiple search terms may be created based on combinations of variables (e.g. name of event, location, date) corresponding to the event based on the variables in the event data. For example, search terms such as “DreamforceSanFrancisco,” “Dreamforce2012,” “2012Dreamforce,” “Dreamforce2012SanFrancisco” may be created and used to search the social network to find members who are potential or actual attendees. Additionally, acronyms, nicknames, and abbreviations may be used. For example, search terms “DF12,” “DF12SFO,” DF12SanFran,” etc. may be created to search a social network to find members who may be attendees at the event. Search terms may also include any symbols or phrases that are used on a variety of social networks to indicate a topic, such as a hashtag or “#.”

Thus, members of a social network at the event and/or referring to the event may be recognized as potential or actual attendees in block 530.

Search terms may also be generated based on other event data corresponding to the identified events as previously discussed. Accordingly, in some implementations, search terms may be based on event data such as the schedule, speakers, topics, sponsors, or other details related to the identified event. For example, if “Marc Benioff” is scheduled to speak at “Dreamforce” in the year “2012” about “Customer Relationship Management” then search terms such as “CRM,” “BenioffCRM,” “BenioffDF12,” etc. may be created. As such, search terms incorporating the incidents or schedule of the event may be used to create search terms and find attendees of the event on the social networking website.

At block 540, attendee data, including potential and actual attendees, is transmitted to the computing device. Attendee data may include usernames, real names, the event, message or content, time that the content was posted, pictures and/or graphics, usernames, contact information (business email, personal email, business phone, personal phone, cell phone, etc.), employment information (title, company, etc.), interests, education, etc. In effect, information available on an attendee's profile on the social network, as well as messages or content, may be extracted from the social network.

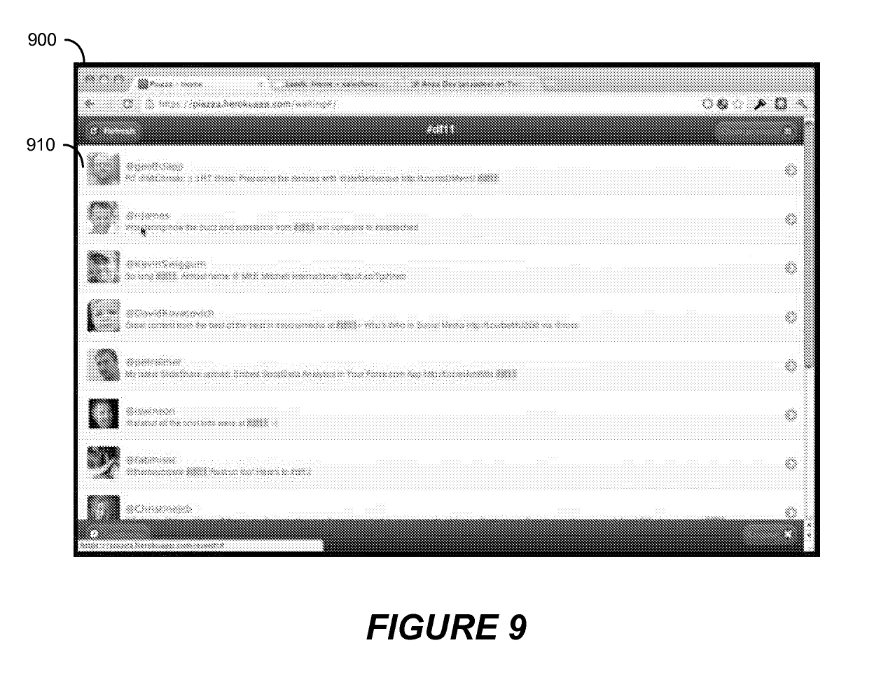

FIG. 9 shows an example of a presentation of one implementation of attendee data in the form of a Graphical User Interface (GUI) 900 as displayed on a display device, according to some implementations. In this example, GUI 900 includes a list of potential and actual attendees 910. The list of potential and actual attendees 910 of FIG. 9 includes a social network member picture (i.e. a picture taken from the member's profile), message that was used to determine the member as a potential or actual attendee, and username for the potential and actual attendees.

At block 550, a message is received from the computing device. For example, the message received at block 550 may include a message from the computing device to one of the members of the social network who are identified as attendees or potential attendees at the selected event. As such, the message may be forwarded to the attendee on the social network.

At block 560, interaction data may be generated. For example, the message forwarded to the attendee on the social network may be included in the interaction data. Additionally, the location of the attendee, name of the event, and content that the attendee posted on the social network may be included in interaction data. Interaction data may also include data regarding any interactions within the blocks of the various methods disclosed herein.

At block 570, the interaction data, as well as other types of data, may be stored. For example, the interaction data may be stored in a database on a server. In some implementations, the interaction data may be stored in a database of a customer relationship management (CRM) system. For example, the message transmitted from the computing device to the member of the social network at block 550 may be identified as “leads” in a marketing or sales environment, and therefore the interaction data, event data, and attendee data may be stored in the CRM system. In other implementations, the attendees identified in block 530 may have their attendee data stored within the CRM system when identified as attendees. Accordingly, the attendees may be logged as leads without generating interaction data. In some implementations, attendee data is stored along with interaction data when a message is sent to an attendee. In some implementations, attendees may also be automatically followed, “friended,” or tracked within the social networks. In other implementations, users may be prompted to confirm whether they wish to follow the attendees within the social network. For example, data providing an indication that particular users should be followed, such as those identified as attendees at an event, may be transmitted to the social network from where attendees were identified. As such, leads may be created in the CRM system. Moreover, attendees may also be followed from within the social network, which the CRM system has access to.

In an implementation, if an attendee is already marked as a lead in the CRM system (i.e., that there is existing interaction or attendee data regarding the user of the social network identified as an attendee), data regarding the user in the CRM system may be updated. For example, event data, attendee data, and/or interaction data may be stored in the CRM system, or used to update information in the CRM system regarding the lead. Any collected data disclosed herein may be stored within the CRM.

FIG. 10 shows a flowchart of an example of a method 1000 for finding people in a physical environment in accordance with some implementations. Method 1000 (and other methods described herein) may be implemented by the architectural components of FIGS. 4A and 4B. In various implementations, blocks may be reordered, omitted, combined, or split into additional blocks for method 1000, as well as other methods described herein.

Similar to block 510 of FIG. 5, in block 1010 of FIG. 10, a server, such as Application Server 50 of FIGS. 4A and 4B, receives location data indicating a location of a computing device. In block 1015, one or more events corresponding to the location data of block 1010 are identified, similar to block 515 of FIG. 5.

In block 1020, the events identified in block 1015 may be filtered. Events may be filtered based on a variety of criteria. For example, events may be filtered such that only technology-related, or other themes, of events may be identified by analyzing the event data. Events may also be filtered to emphasize types (e.g., seminars, speeches, conferences, etc.), time, topics, distance, and cost (e.g., free events, events within a certain cost range, etc.).

Additionally, events may also be filtered based on the size of the events. For example, when events are identified in block 1015, the data may include the size of the events (e.g., maximum registrations or actual registrations). Accordingly, events below a certain size, or above a certain size, may be filtered out of the identified events.

Events may also be filtered in block 1015 based on event-related activity on social networks. For example, as explained previously for block 530 and below for block 1030, one or more potential or actual attendees of an event may be identified on a social network by analyzing content or interactions on the social network. Accordingly, events below or above a certain threshold of content or interactions may be filtered out. For example, events may be filtered based on the number of textual comments made by members related to the event. As another example, events may be filtered based on the number of unique members posting content or interactions related to the event. As a third example, events may be filtered based on the number of “like” or recommendation interactions on the social network.

In some implementations, the events may be configured in a list with priority given to events based on the preceding filtering variables, similar to configuring the list of attendees as in block 1035 below.

In block 1025, event data is transmitted to the computing device. In block 1030, one or more potential or actual attendees may be identified, as in block 530 of FIG. 5.

In block 1035, a list of attendees may be configured. In some implementations, the list of potential or actual attendees may be ordered to emphasize or prioritize certain characteristics of the attendees. In other implementations, the list of attendees may be filtered. For example, if information regarding the attendee is already stored in interaction data (as discussed above with block 560 and block 1050 below), the attendee may be pushed up a list of attendees to emphasize prior relationships or interactions. Accordingly, attendees identified in the stored interaction data may be given priority in presentation (e.g., displayed before attendees without stored interaction data, displayed with textual or graphical indications, etc.). Alternatively, attendees without prior interaction data may be filtered out. As such, attendees with prior history of interactions may be the only attendees on a configured list. Additionally, attendees with more interaction data may be given priority over attendees with less interaction data. Alternatively, the attendees below a certain threshold of interaction data may be filtered out. The threshold of interaction data may correspond to a certain quantity of interactions. For example, a certain minimum number of exchanged messages, received messages, conferences attended, etc. may set the threshold of interaction data. Additionally, quality-related thresholds of interaction data may be used. For example, interaction data may also include reviews, ratings, number of followers the attendee has on the social network, etc. In other implementations, the list of attendees may be configured based on time the content or interactions were posted to the social network.

In some implementations, attendees with certain employers, occupations, level within an organizational hierarchy, or titles may be given priority. For example, as discussed previously with block 540, attendee-related data such as potential and actual attendees, the event, message or content, time that the content was posted, pictures and/or graphics, usernames, real names, contact information (business email, personal email, business phone, personal phone, cell phone, etc.), employment information (title, company, etc.), etc. may be collected from the social network and stored. As such, existing attendee data regarding attendees may be accessed and analyzed to determine if the attendee has certain employment characteristics. For example, attendees who are purchasers, salespeople, executives, account managers, or other sales or marketing related roles may be emphasized. Accordingly, these attendees may be given a priority with relation to the rest of the attendees.

Additionally, the attendee content that was posted to recognize the attendee as a potential or actual attendee to the event may be analyzed, such as through keyword searching or semantics analysis, to determine the attendee's goals or intent in regard to attending the event. As such, attendees who are attending the event in a sales capacity, such as looking to purchase, sell, or look at particular products or services at the event may be given priority when the list of attendees is configured. For example, an attendee may post a textual message on the social network, stating “I can't wait for the #HomeandGardenExpo to show off my new Lasertron5000. It's a revolutionary way to keep those pesky kids off your lawn!” If the attendee is identified as attending the “Home and Garden Expo” to showcase the product “Lasertron5000,” the attendee may be further identified as a seller, and therefore, given priority when the list of attendees is configured. As another example, an attendee may post a message on a social network, stating “We need some widgets to complete the Lasertron5000, hope we can get them at the #HomeandGardenExpo!” Accordingly, the attendee may be further identified as a purchaser, and therefore, also given priority when the list of attendees is configured.

In an implementation, a social network member's profile or messages may be searched for certain keywords and prioritized if the keyword is found within the profile or message.

In some implementations, the list of attendees may also be configured such that attendees identified as actual attendees may be given priority over attendees who are identified as potential attendees. Accordingly, attendees who are identified as at the event may be given priority when the list is configured over potential attendees.

Additionally, as discussed with respect to block 515 and FIG. 6, events may have multiple sub-events. In some implementations, the list of attendees may be configured such that attendees at certain sub-events may be given priority over other attendees.

As an example, FIG. 11 shows an event such as the “San Jose Renaissance Faire” 1100 with sub-events Performer Stage 1110, Jousting Competition 1120, and Fairground 1130. In FIG. 11, the sub-events may be ongoing at the same time, overlap, or be held at different times. In any case, each is a different sub-event within the event 1100.

Attendees may be identified as posting content from a sub-event in accordance with the previous discussion related to block 530 above. For example, a first user may post content on a social network including the message “Lord Hawthorne just unseated the Black Knight in the jousting competition! #SanJoseRenFaire.” A second user may post content including the message “Sarah is selling Frankish-style chainmail at booth 323 at the San Jose Renaissance Faire! It's GORGEOUS!” A third user may post content including the message “The Three Squires are giving the best performance at the SJRF!” Finally, a fourth user may post content including a graphical advertisement for the “San Jose Renaissance Faire.” Accordingly, the first user may be identified as being at the Jousting Competition 1120 within San Jose Renaissance Faire 1100 because the attendee is discussing the sub-event, persons participating within the sub-event, or identifying an incident which occurred, is occurring, or will occur at the sub-event. Likewise, the second user may be identified as being at Fairground 1130 because the attendee is discussing a merchant selling an item at a booth at the San Jose Renaissance Faire 1100. The third user may be identified as an attendee at the Performer Stage 1100 for reasons previously discussed. Finally, the fourth user may be identified as a general attendee of San Jose Renaissance Faire 1100 because the user posted content related to the main event, the San Jose Renaissance Faire 1100 rather than a sub-event.

Accordingly, the list of attendees may be configured to give priority to certain attendees. In some implementations, attendees at the same sub-events as user system 12 of FIG. 4A may be given priority over attendees at different sub-events. In other implementations, the order may be set based on the distance between the location received from the user system and the sub-event. In some implementations, attendees at certain sub-events may be filtered out, or alternatively, prioritized.

As such, content posted on the social network may be analyzed to determine which sub-event the attendee is referring to, and therefore, the list of attendees may be configured to give priority to attendees at certain sub-events within the event.

In an implementation, attendees may also be prioritized based on which social network was used to determine that the social network member is an attendee. For example, a first user may be identified as an attendee on a business-oriented social network whereas a second user may be identified as an attendee on a personal-oriented social network. Accordingly, in one implementation, the first user may be prioritized over the second user because the source used to determine the user as an attendee, such as the business-oriented social network, is given emphasis or priority over the source used to determine that the second user is an attendee, such as the personal-oriented social network.

At block 1040, the attendee data may be transmitted to the computing device, as described in block 540. At block 1045, a message from the computing device may be received. For example, the message received may be a textual message meant to be sent to one of the users of the social network identified as an attendee.

In some implementations, generated or prepared responses to send to an attendee may be presented to the computing device. For example, if a member of a social network is identified as an attendee at the event “Dreamforce” in the year “2012,” a generated or prepared response such as “I see you're at #df12, want to get together for a quick chat?” may be created and potentially transmitted to the member of the social network. The responses may include a variety of data, including data in interaction data, data in attendee data, event data such as event name or other event data (speakers, topics, etc. as previously disclosed herein), search terms, etc. Additionally, the prepared responses may include acronyms, abbreviations, nicknames, or combinations of the data.

In block 1050, interaction data may be generated as previously discussed above with respect to block 560. For example, if a message is received from a computing device to be transmitted to an attendee, the message may be recorded as interaction data. Moreover, attendee data and/or event data related to the attendee may also be stored. Additionally, a command may be received from a computing device to store attendee and/or event data regarding an attendee without sending a message to the attendee (i.e., without creating interaction data). Accordingly, interaction, event and/or attendee data may be stored, and used as previously discussed with respect to block 1035 when configuring the list of attendees to give priority to certain attendees.

In block 1055, interaction data and/or attendee and event data may be stored, for example, in a database on a system or server.

FIG. 12 shows an example of a presentation of data in the form of a Graphical User Interface (GUI) 1300 as displayed on a display device, according to some implementations. In this example, GUI 1300 includes attendee data 1310, prepared responses 1320, interaction data display 1330, and generate interaction data button 1340. Attendee data 1301, in FIG. 12, includes an attendee's name, username, and content that was used to identify the member of the social network as an attendee of the event. Prepared responses 1320 may include multiple different types of responses. Interaction data display 1330 may include a variety of information stored as interaction data in block 1055. As such, a history of interactions with the attendee may be displayed. Additionally, in FIG. 12, a generate interaction data button 1340 is displayed and configured to generate interaction data without the need to have one of the prepared responses selected.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer implemented method for finding people in a physical environment, the method comprising:
receiving, at a server, location data indicating a location of a user;
identifying one or more events corresponding to the location of the user;
transmitting event data indicating the one or more events to a computing device associated with the user;
identifying one or more attendees at an event selected from the one or more events;
transmitting attendee data indicating the one or more attendees to the computing device;
receiving a message from the computing device, the message addressed to the one or more attendees;
generating interaction data in response to receiving the message, wherein the interaction data includes the received message and information indicating the one or more attendees to whom the message is addressed; and
storing the interaction data in a record on a database.

2. The method of claim 1, further comprising:
accessing, at the server, the interaction data stored in the record on the database;
determining if the one or more attendees are identified in the stored interaction data; and
configuring a list of the one or more attendees such that attendees identified in the stored interaction data are displayed before attendees not identified in the stored interaction data.

3. The method of claim 1, wherein the identified one or more events are filtered based on criteria specified by the user.

4. The method of claim 1, wherein the interaction data includes a location of the event and a name of the event.

5. The method of claim 1, wherein the one or more attendees are identified from content posted on a social network.

6. The method of claim 5, wherein the interaction data includes the content.

7. The method of claim 1, further comprising:
transmitting attendee content regarding the selected event from a social network to the computing device.

8. The method of claim 1, wherein the identified one or more events are within a predetermined distance from the computing device.

9. The method of claim 1, further comprising:
providing a list of prepared responses to send to the one or more attendees, wherein the prepared responses include a name of the selected event.

10. The method of claim 1, wherein the event data is obtained from a first social network, and the attendee data is obtained from a second social network.

11. The method of claim 10, wherein user credentials to access the first social network and the second social network are stored on the server.

12. The method of claim 1, further comprising:
filtering the one or more attendees based on criteria, the criteria including keywords found within social network profiles of the attendees.

13. The method of claim 1, wherein the transmitted attendee data prioritizes a first attendee over a second attendee, the first attendee identified as attending the event in a sales capacity.

14. The method of claim 1, wherein the computing device is a portable electronic device.

15. The method of claim 1, wherein attendees are identified as at the event based on searching content posted by the attendees on a social network.

16. The method of claim 15, wherein content on the social network is searched based on search terms, the search terms based on a combination of variables regarding the event received from an events server.

17. The method of claim 16, wherein the combination of variables includes a name of the event, a date, and a location.

18. The method of claim 1, wherein the attendee data includes social network user names of attendees.

19. The method of claim 1, wherein the attendee data includes employment information of the identified attendees.

20. The method of claim 1, further comprising:
configuring a list of the one or more attendees such that attendees identified on a first social network are prioritized over attendees identified on a second social network.

21. A computer implemented method for finding people in a physical environment, the method comprising:
receiving, at a server, location data indicating a location of a user;
identifying one or more events corresponding to the location of the user;
transmitting event data indicating the one or more events to a computing device associated with the user;
identifying one or more attendees at an event selected from the one or more events, wherein the attendees are identified on a social network;
transmitting attendee data indicating the one or more attendees to the computing device; and
transmitting data to the social network indicating that the identified one or more attendees at the event are to be followed within the social network.

22. A computer implemented method for finding people in a physical environment, the method comprising:
identifying one or more attendees at an event by searching a social network;
transmitting attendee data indicating the one or more attendees to the computing device;
receiving a message from the computing device, the message addressed to the one or more attendees;
generating interaction data in response to receiving the message, wherein the interaction data includes the received message and information indicating the one or more attendees to whom the message is addressed;
storing the interaction data in a record on a database; and
transmitting data to the social network indicating that the identified one or more attendees at the event are to be followed within the social network.

23. One or more computing devices for finding people in a physical environment, the one or more computing devices comprising:
one or more processors operable to execute one or more instructions to:
receive, at a server, location data indicating a location of a user;
identify one or more events corresponding to the location of the user;
transmit event data indicating the one or more events to a computing device associated with the user;
identify one or more attendees at an event selected from the one or more events;
transmit attendee data indicating the one or more attendees to the computing device;
receive a message from the computing device, the message addressed to the one or more attendees;
generate interaction data in response to receiving the message, wherein the interaction data includes the received message and information indicating the one or more attendees to whom the message is addressed; and
store the interaction data in a record on a database.

24. A non-transitory computer-readable storage medium storing instructions executable by a computing device to perform a method for finding people in a physical environment, the method comprising:
receiving, at a server, location data indicating a location of a user;
identifying one or more events corresponding to the location of the user;
transmitting event data indicating the one or more events to a computing device associated with the user;
identifying one or more attendees at an event selected from the one or more events;
transmitting attendee data indicating the one or more attendees to the computing device;
receiving a message from the computing device, the message addressed to the one or more attendees;
generating interaction data in response to receiving the message, wherein the interaction data includes the received message and information indicating the one or more attendees to whom the message is addressed; and
storing the interaction data in a record on a database.
